(19) United States
(12) Patent Application Publication
(10) Pub. No.: US 2008/0041786 A1
(43) Pub. Date: Feb. 21, 2008

(54) Methods and apparatus for the removal of organic matter and related degradation products from water

(76) Inventor: John Anthony Strawn, Ormond Beach, FL (US)

Correspondence Address: WILSON DANIEL SWAYZE, JR., 3804 CLEARWATER CT., PLANO, TX, 75025, US

(21) Appl. No.: 11/859,779

(22) Filed: Sep. 23, 2007

Related U.S. Application Data
(62) Division of application No. 11/008,031, filed on Dec. 9, 2004.

(51) Int. Cl. C02F 3/00; B01D 24/02; C02F 3/30; B01D 24/48

(52) U.S. Cl. 210/610; 210/167.22; 210/170.02; 210/198.1; 210/209; 210/87

(57) ABSTRACT

A device for the removal of organic matter and related degradation products from water, includes a container through which the water containing organic matter and/or nitrates is passed through at a controlled rate and a check valve used in conjunction with the container for the removal of organic matter and related degradation products from water and for introducing bacteriophilic nutrients.

### PRIORITY/RELATED APPLICATIONS

The present application is a divisional application of the parent application with a Ser. No. 11/008,031 filed on Dec. 9, 2004. The present application claims priority under 35 USC 119 by provisional application 60/556, 203 filed Apr. 29, 2004 which is incorporated by reference.

### FIELD OF INVENTION

The invention is an improvement of a process for the removal of organic matter and related degradation products from water.

### BACKGROUND OF THE INVENTION

There have been many apparatus and processes to remove organic matter and related degradation products from water. The removal of this organic matter is important in order to sustain the life of fish and other animals dependent on water. Several different types of media to sustain the growth of bacteria related to the process of removal of organic matter have been proposed. Likewise, various methods of introducing nutrients into devices into the media designed to remove organic matter and related degradation products from water have been proposed which are often inclusive in the media. They all strive to achieve the same goal, which is to reduce the level of organic matter and/or nitrates from water. They generally consist of a container through which water containing organic matter and/or nitrates is passed at a reduced rate and in which aerobic and anaerobic bacteria successfully break down the unwanted substances. Typically, the aerobic and anaerobic bacteria need to be exposed to some type of carbon-based nutrient to be successful.

The following table shows references cited

### U.S. PATENT DOCUMENTS

U.S. Pat. No. 4,353,800, October, 1982, Besik, 210/605.
U.S. Pat. No. 4,442,005, April, 1984, Breider, 210/614.
U.S. Pat. No. 4,551,250, November, 1985, Morper et al., 210/603.
U.S. Pat. No. 4,620,929, November, 1986, Hofmann, 210/610.
U.S. Pat. No. 4,968,427, November, 1990, Glanser et al., 210/615.
U.S. Pat. No. 4,995,980, February, 1991, Jaubert, 210/602.
U.S. Pat. No. 5,078,882, January, 1992, Northrop, 210/617.
U.S. Pat. No. 5,242,592, September, 1993, Ballnus, 210/605.
U.S. Pat. No. 5,348,653, September, 1994, Rovel, 210/605.
U.S. Pat. No. 5,413,713, May, 1995, Day et al., 210/605.
U.S. Pat. No. 5,599,451, February, 1997, Guiot, 210/605.
U.S. Pat. No. 5,702,572, December, 1997, Fujimura et al., 210/605.
U.S. Pat. No. 5,711,020, January, 1998, Wolfe et al., 588/203.
U.S. Pat. No. 6,171,480, January, 2001, Lee et al., 210/85.
U.S. Pat. No. 6,630,067, October, 2003, Shieh et al., 210/259.

### OTHER REFERENCES

Knowles, R., “Denitrification,” Microbiol. Rev. 46:43-70, American Society for Microbiology (1982).
McClintock, S. A., et al., “Nitrate versus oxygen respiration in the activated sludge process,” J. Wat. Poll. Cont. Fed. 60:342-350, Water Pollution Control Federation (1988).
Monteith, H. D., et al., “Industrial Waste Carbon Sources for Biological Denitrification,” Prog. Wat. Tech. 12:127-141, Pergamon Press Ltd. (1980).
Sharma, B. and Ahler, R. C., “Nitrification and Nitrogen Removal,” Wat. Res. 11:897-925, Pergamon Press Ltd. (1977).
Wiesmann, U., “Biological Nitrogen Removal from Wastewater,” Adv. Biochem. Eng. Biotechnol. 51:113-154, Springer-Verlag (1994).

### SUMMARY

The invention improves upon process for the removal of organic matter and related degradation products from water by the addition of an inlet connected to a check valve into which bacteriophilic nutrients can be inserted and/or injected, the use of loose fiberglass filter media as a substrate for bacterial growth, and the use of an external metered flow control valve that can be used to properly and precisely measure the water flow.

This invention solves the problem of how to get bacteriophilic nutrients to the bacteria in the device easily, effectively and economically. It proposes an improved inert culture media, fiberglass filter floss such as that commonly found in air conditioning filters, for any device designed for the removal of organic matter and related degradation products from water. Lastly, the invention proposes a solution to adequately measuring the outflow of a device, which is essential to its performance.

### BRIEF DESCRIPTION OF THE DRAWING

FIG. 1 illustrates a cross section of the present invention;

FIG. 2 illustrates a detailed view of an additional check value.

### DETAILED DESCRIPTION

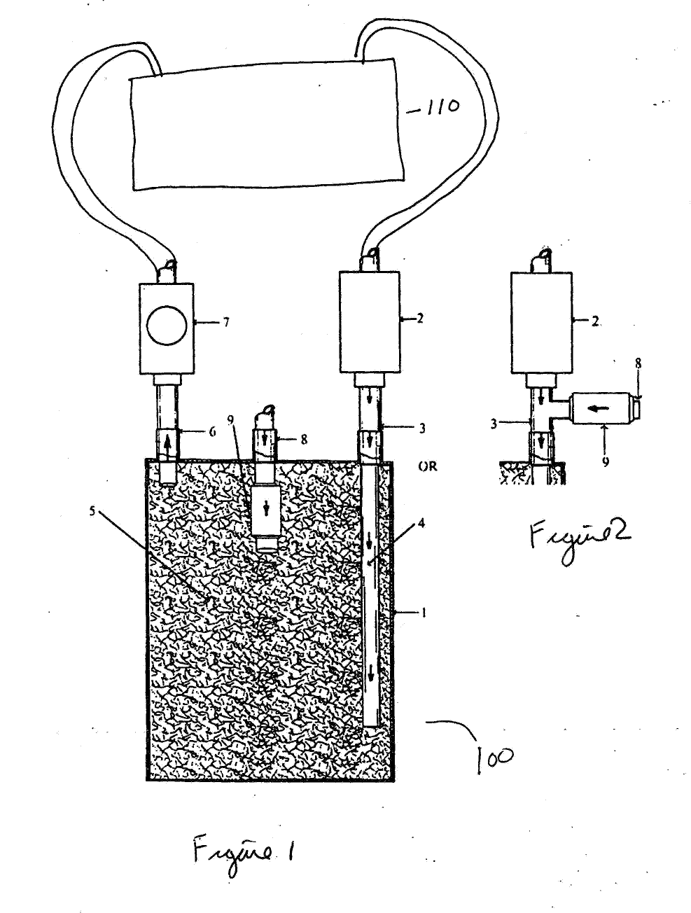

A device 100 as shown in FIG. 1 for carrying out the process according to the invention includes at least one filter chamber (1) which includes an inlet line (3), an outlet line (6), a third inlet line (8) connected to a check valve 9 into which nutrients can be inserted or injected, and which is at least partially filled with the filter material.

The invention is illustrated in detail below with FIGS. 1 and 2.

FIG. 1 shows a section through a filter including a container (1) that is closed on all sides to prevent water from escaping. A tubular inlet line (3) is attached to the container (1) on one side of the container (1) to allow water that is to be filtered to enter the container (1), and an outlet line (6) is also attached on the side to allow the water to be removed from the container (1) after the water has been cleaned. Another inlet line (8) that is connected to a check valve (9) also can be present into which nutrients can be inserted or injected. In practice, the inlets (3, 8) and outlet port (6) can be placed anywhere on the device (100).

Water normally is forced through the device (100) by the use of a pump (2). However, other ways of force such as those used in a siphon can be used on the outlet line (6). Water containing organic matter and/or nitrates then travel through an internal tube (4) which may be porous so that the end position of the inlet line (3) is in spaced relation to the outlet line (6), forcing the water containing organic matter and/or nitrates to travel through the substrate (5). A substrate (5) which may partially or completely fill the container (1) to which this particular invention pertains is loose fiberglass filter media such as that commonly found in air conditioning filters.

The water containing organic matter and/or nitrates enters the container (1) through the inlet line (3) then exits the container (1) through the outlet line 6 and the flow of the water is slowed and is exactly measured by the use of an external metered flow control valve or flowmeter (7). The flowmeter could be placed on the inlet line (3) as well as the outlet line (6) and just a tube would be used as the outlet line in this case.

The invention has a check valve (9) which can be connected to a third inlet line (8) or even to the main inlet line (3) by which bacteriophilic nutrients can be forced, inserted, or injected into the device.

### EXAMPLE

A volume of a container (1) sufficient to purify a 100-gallon aquarium 110 would be about 720 cubic inches or 3.12 gallons. The primary container is loosely filled with loose fiberglass filter media such as that commonly found in air conditioning filters. A small pump (2) powerful enough to pump water through the container is connected to the inlet line (3) and placed in the aquarium. The water flows completely through the filter media (4 and 5) and exits via the outlet line (6). An external metered flow control valve or flowmeter (7) controls the flow and in this example reduce it to 12 ml per minute The volume of the container to sufficiently remove the organic matter and nitrates from a volume of water may be around 2% of the volume of water. A container with a volume approximately 2-10% of the body of water to be cleaned is sufficient for most applications. A larger container can be used in specific applications in water heavily contaminated with nitrates and organic matter and the size of the container is primarily limited by its practicality. The flow rate of the container may range from 2% to 30% of the volume of the filter container per hour and can be specifically adjusted to the application. A slower flow rate may be inefficient and a faster flow rate will inhibit the anaerobic bacteria necessary for the function of the device.

Nutrients should be regularly injected into the primary container via the check valve (8 and 9), which will provide energy for the aerobic and anaerobic bacteria to break down the organic waste and nitrates.

The removal of organic matter and related degradation products from water is achieved by using substrate (5) such as a loose filter material in an inert container into which the bacteriophilic nutrients are fed from the outside. The bacteria naturally will set up an aerobic reaction zone and an anaerobic reaction zone in the filter material. One chamber can be used or multiple chambers can be used to facilitate this process.

The container (1) can be plastics material, or any other material suitable for use as a container for water. The bacteriophilic nutrients used can be sucrose, lactose, dextrose, compounds of phthalic acid and derivatives thereof, ethanol, methanol, acetate or any combination of nutrients. It is equally possible also to use other bacteriophilic nutrients, as the nutrient can generally be any one of many carbon compounds. The present invention utilizes a check valve to inject, force, or insert the nutrients into the container (1). The check valve (9) is used because the container (1) is slightly pressurized due to the water being forced through it.

When the process is used, any filter material equipped with a large surface area forms the substrate (1) into which bacteriophilic nutrients are fed in from the check valve (9) so that the desired microorganisms can establish themselves on the substrate very rapidly and can multiply explosively. The present invention uses loose fiberglass floss filter media, such as that commonly used in household air conditioning, as an inert media that has proven to be inexpensive and yet highly effective.

Mainly, so-called nitrifying bacteria (nitrate bacteria) that oxidize to nitrate the ammonia formed by the decomposition of protein, establish themselves in an aerobic zone. These organisms are primarily representatives of the genera Nitrosomonas and Nitrobacter that live together in a parasymbiontic manner, the former being nitrite-formers and the latter being nitrate-formers.

Primarily, denitrifying bacteria, for example Pseudomonas stutzeri and Micrococcus denitrificans, establish themselves in the anaerobic zone. These anaerobic bacteria utilize the oxygen liberated in the reduction of nitrates as a hydrogen acceptor for the breakdown of organic nutrients.

The formation of the aerobic and anaerobic zones is achieved by flushing the filter material by the water to be purified at a comparatively low flow rate. An aerobic zone is then first set up in the filter material, and an anaerobic zone is then set up behind this, in the direction of flow, depending on the content of oxygen remaining in the water.

It is found that an inert filter media is loose fiberglass filter media such as that commonly found in air conditioning filters. The media works well because it is inert, loosely woven so that it will not clog even without any other mechanical filtration under most circumstances, provides a large surface area for bacteria and is economical. Other filter media types have been used to remove organic matter and related degradation products from water however, which could be used separately with the other claims.

The rate of flow can be varied according to individual needs. The rate will vary according to the volume of the primary container. However, it must be kept at a relatively slow rate. To accurately measure the outflow of the device, it is proposed that an external metered flow control valve (7) or flow meter be used to properly and precisely measure the outflow.

The process may be used in aquaria or fish-farming ponds; under these circumstances the returned water may have low oxygen content. To avoid damage to the fish, the purified water is returned to the aquarium or fish-farming pond by free trickling contact with air or via a diffuser; so that it can thus re-absorb the oxygen it has lost and can also give up the gaseous nitrogen.

1). A device for the removal of organic matter and related degradation products from water, comprising:
a container through which said water containing organic matter and/or nitrates is passed through at a controlled rate; and
a check valve used in conjunction with said container for the removal of organic matter and related degradation products from water and for introducing bacteriophilic nutrients.

2). A device for the removal of organic matter and related degradation products from water as in claim 1, wherein said container includes a fiberglass filter media.

3). A device for the removal of organic matter and related degradation products from water as in claim 1, wherein said container includes a flowmeter to control the flow of the water into the container.

4). A device for the removal of organic matter and related degradation products from water as in claim 1, wherein said flow meter is located at an input to said container.

5). A device for the removal of organic matter and related degradation products from water as in claim 1, wherein said flow meter is located at an output of said container.

6). A method for the removal of organic matter and related degradation products from water, comprising the steps of:
passing water containing organic matter and/or nitrates through a container at a controlled rate; and
introducing bacteriophilic nutrients with a check valve used in conjunction with said container for the removal of organic matter and related degradation products from water.

7). A method for the removal of organic matter and related degradation products from water as in claim 6, wherein said method includes the step of filtering the water with a fiberglass filter media.

8). A method for the removal of organic matter and related degradation products from water as in claim 6, wherein said method includes the step of controlling the flow of the water into the container.

9). A method for the removal of organic matter and related degradation products from water as in claim 6, wherein said control is with flow meter located at an input to said container.

10). A method for the removal of organic matter and related degradation products from water as in claim 6, wherein said control is with a flow meter located at an output of said container.

11). A system for the removal of organic matter and related degradation products from water, comprising:
a container through which said water containing organic matter and/or nitrates is passed through at a controlled rate; and
a check valve used in conjunction with said container for the removal of organic matter and related degradation products from water and for introducing bacteriophilic nutrients.

12). A system for the removal of organic matter and related degradation products from water as in claim 11, wherein said container includes a fiberglass filter media.

13). A system for the removal of organic matter and related degradation products from water as in claim 11, wherein said container includes a flowmeter to control the flow of the water into the container.

14). A device for the removal of organic matter and related degradation products from water as in claim 11, wherein said flow meter is located at an input to said container.

15). A system for the removal of organic matter and related degradation products from water as in claim 11, wherein said flow meter is located at an output of said container.

16). A system for the removal of organic matter and related degradation products from water as in claim 11, wherein said system includes an aquarium.

15). A system for the removal of organic matter and related degradation products from water as in claim 11, wherein said system includes a fish pond.
